(19) United States
(12) Patent Application Publication
(10) Pub. No.: US 2011/0279424 A1
(43) Pub. Date: Nov. 17, 2011

(54) DISPLAY DEVICE AND DRIVING CIRCUIT THEREOF

(75) Inventors: Yu-Feng Lin, Tainan County (TW); Yaw-Guang Chang, Tainan County (TW)

(73) Assignee: HIMAX TECHNOLOGIES LIMITED, Tainan County (TW)

(21) Appl. No.: 12/777,502

(22) Filed: May 11, 2010

(51) Int. Cl. G09G 5/00

(52) U.S. Cl. 345/205

(57) ABSTRACT

A display device including a display panel and a driving circuit is provided, wherein the driving circuit includes a synchronizer and a driver. The synchronizer synchronizes a plurality of external control signals according to an internal clock and accordingly generates a plurality of internal control signals. The driver reads the internal control signals according to the internal clock and accordingly generates a plurality of driving signals to drive the display panel.

### BACKGROUND OF THE INVENTION

1. Field of the Invention

The present invention generally relates to a display device and a driving circuit thereof, and more particularly, to a display device and a driving circuit thereof with a built-in synchronizer.

2. Description of Related Art

FIG. 1 is a diagram of an existing display device. As shown in FIG. 1, the display device 100 includes a display panel 110 and a driving circuit 120. The display device 100 receives an external clock CLK1 and a plurality of external control signals (for example, a vertical synchronization signal Vsyn1 and a horizontal synchronization signal Hsyn1, etc.) from an external circuit. Generally speaking, the external clock CLK1 is a precision clock generated by a crystal oscillator. The driving circuit 120 reads the external control signals according to the external clock CLK1 and accordingly generates driving signals (for example, a gate driving signal GD1 and a source driving signal SD1, etc) for driving the display panel 110.

FIG. 2A and FIG. 2B are respectively a timing diagram and a spectrum diagram of the external clock CLK1. As shown in FIG. 2A and FIG. 2B, because the external clock CLK1 generated by the crystal oscillator is very precise, the energy of the external clock CLK1 is usually focused at a specific frequency. On the other hand, electro-magnetic interference (EMI) of single-frequency harmonic induced by the external clock CLK1 is very serious. Since to most electronic devices, EMI is a very common and annoying interference that can interrupt, block, attenuate, or restrict the performance of the device or the entire circuit, how to reduce the impact of EMI to a display device has become one of the major subjects in display device design.

### SUMMARY OF THE INVENTION

Accordingly, the present invention is directed to a driving circuit, wherein external control signals are converted into internal control signals by a synchronizer according to an internal clock, so that electro-magnetic interference (EMI) induced by an external clock is reduced.

The present invention is also directed to a display device, wherein EMI induced by single-frequency harmonic is reduced.

The present invention provides a driving circuit for driving a display panel, wherein the driving circuit includes a synchronizer and a driver. The synchronizer synchronizes a plurality of external control signals according to an internal clock and accordingly generates a plurality of internal control signals. The driver reads the internal control signals according to the internal clock and accordingly generates a plurality of driving signals to drive the display panel.

According to an embodiment of the present invention, the driving circuit further includes a clock generator for generating the internal clock. In addition, according to an embodiment of the present invention, the clock generator is a RC oscillator.

The present invention also provides a display device including a display panel and a driving circuit. The driving circuit includes a synchronizer and a driver. The synchronizer synchronizes a plurality of external control signals according to an internal clock and accordingly generates a plurality of internal control signals. The driver reads the internal control signals according to the internal clock and accordingly generates a plurality of driving signals to drive the display panel.

As described above, in the present invention, a plurality of external control signals is converted into a plurality of internal control signals by a synchronizer according to an internal clock. Thereby, the display device and the driving circuit thereof provided by the present invention work according to the internal clock so that EMI induced by an external clock is reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of an existing display device.

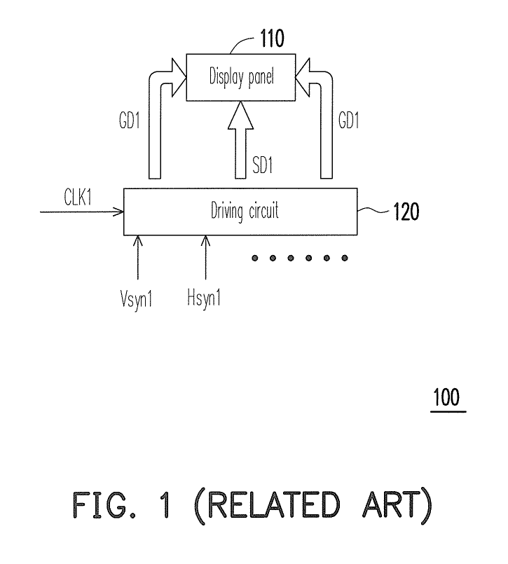

FIG. 2A and FIG. 2B are respectively a timing diagram and a spectrum diagram of an external clock.

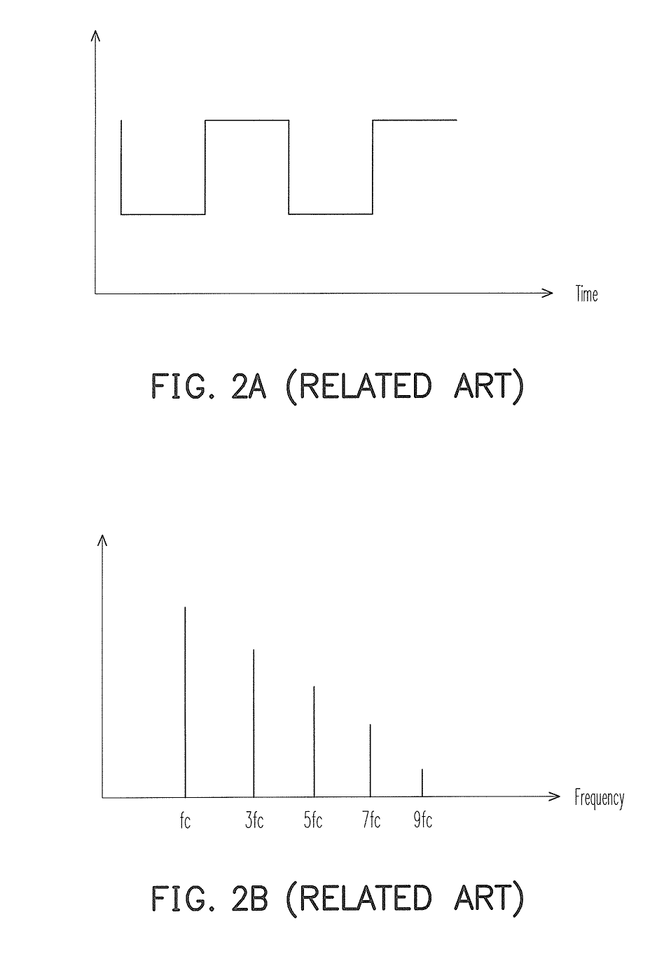

FIG. 3 is a diagram of a display device according to an embodiment of the present invention.

FIG. 4 is a timing diagram of the embodiment in FIG. 3.

FIG. 5A and FIG. 5B are respectively a timing diagram and a spectrum diagram of an internal clock according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

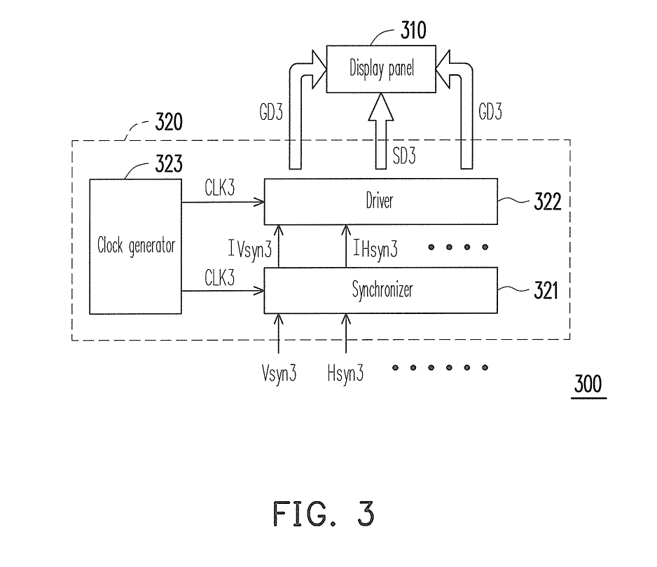

FIG. 3 is a diagram of a display device according to an embodiment of the present invention. As shown in FIG. 3, the display device 300 includes a display panel 310 and a driving circuit 320, and the driving circuit 320 includes a synchronizer 321, a driver 322, and a clock generator 323. The synchronizer 321 is electrically connected to the driver 322, and the clock generator 323 is electrically connected to the synchronizer 321 and the driver 322.

Referring to FIG. 3 again, the display device 300 receives a plurality of external control signals (for example, a vertical synchronization signal Vsyn3 and a horizontal synchronization signal Hsyn3, etc.) from an external circuit. The clock generator 323 generates an internal clock CLK3. The synchronizer 321 synchronizes the external control signals according to the internal clock CLK3 and accordingly generates a plurality of internal control signals (for example, a vertical synchronization signal IVsyn3 and a horizontal synchronization signal IHsyn3, etc). The driver 322 reads the internal control signals according to the internal clock CLK3 and accordingly generates a plurality of driving signals (for example, a gate driving signal GD3 and a source driving signal SD3, etc) to drive the display panel 310.

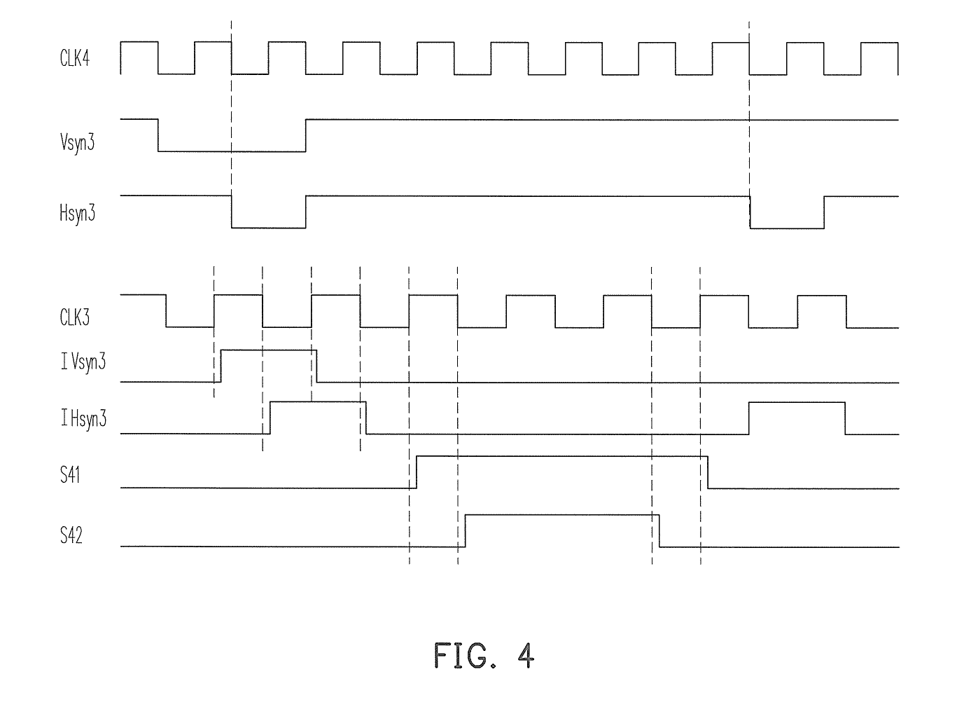

FIG. 4 is a timing diagram of the embodiment in FIG. 3, wherein an external clock CLK4 received from the external circuit is further illustrated. As shown in FIG. 4, generally speaking, the vertical synchronization signal Vsyn3 and the horizontal synchronization signal Hsyn3 are synchronized according to the external clock CLK4. However, in the present embodiment, the synchronizer 321 synchronizes the vertical synchronization signal Vsyn3 and the horizontal synchronization signal Hsyn3 according to the internal clock CLK3 and accordingly generates the vertical synchronization signal IVsyn3 and the horizontal synchronization signal IHsyn3 based on the internal clock CLK3. On the other hand, the driver 322 generates the control signals S41 and S42 respectively related to the source driving signal SD3 and the gate driving signal GD3 according to the vertical synchronization signal IVsyn3 and the horizontal synchronization signal IHsyn3. In other words, the driving circuit 320 converts the external control signals based on the external clock CLK4 into the internal control signals based on the internal clock CLK3 by using the synchronizer 321.

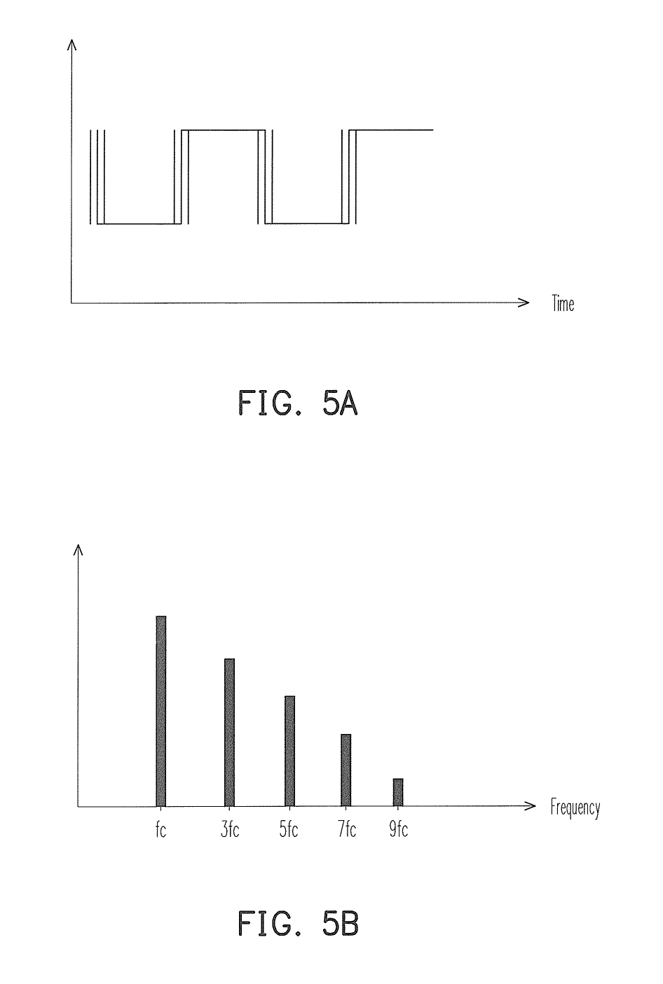

It should be noted that in the present embodiment, the clock generator 323 is not composed of a crystal oscillator but a RC oscillator. Thus, compared to the external clock CLK4 generated by a crystal oscillator, the internal clock CLK3 has lower stability and some jitter. FIG. 5A and FIG. 5B are respectively a timing diagram and a spectrum diagram of an internal clock according to an embodiment of the present invention. As shown in FIG. 5A and FIG. 5B, because the internal clock CLK3 has some jitter, the energy thereof at a specific frequency is reduced compared to that of the external clock CLK4. Accordingly, the impact of electro-magnetic interference (EMI) on the display device 300 is reduced.

As described above, in the present invention, a plurality of external control signals based on an external clock is converted into a plurality of internal control signals based on an internal clock by a synchronizer. In addition, a driver generates the driving signals for driving a display panel according to the internal clock. In other words, a display device and a driving circuit thereof in the present invention work according to the internal clock so that EMI induced by the external clock is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving circuit, for driving a display panel, the driving circuit comprising:
a synchronizer, for synchronizing a plurality of external control signals according to an internal clock and accordingly generating a plurality of internal control signals; and
a driver, for reading the internal control signals according to the internal clock and accordingly generating a plurality of driving signals to drive the display panel.

2. The driving circuit according to claim 1 further comprising a clock generator for generating the internal clock.

3. The driving circuit according to claim 2, wherein the clock generator is a RC oscillator.

4. A display device, comprising:
a display panel; and
a driving circuit, comprising:
a synchronizer, for synchronizing a plurality of external control signals according to an internal clock and accordingly generating a plurality of internal control signals; and
a driver, for reading the internal control signals according to the internal clock and accordingly generating a plurality of driving signals to drive the display panel.

5. The display device according to claim 4, wherein the driving circuit further comprises a clock generator for generating the internal clock.

6. The display device according to claim 5, wherein the clock generator is a RC oscillator.
